(19) United States
(12) Patent Application Publication
(10) Pub. No.: US 2022/0283382 A1
(43) Pub. Date: Sep. 8, 2022

(54) FIXING MEMBER, OPTICAL CONNECTOR, OPTICAL CABLE WITH PULLING END, AND OPTICAL CABLE LAYING METHOD

(71) Applicant: FUJIKURA LTD., Tokyo (JP)

(72) Inventors: Ryoichi Mitobe, Chiba (JP); Shuhei Kanno, Chiba (JP)

(73) Assignee: FUJIKURA LTD., Tokyo (JP)

(21) Appl. No.: 17/637,947

(22) PCT Filed: Oct. 29, 2020
(86) PCT No.: PCT/JP2020/040567

§ 371 Date: Feb. 24, 2022

(30) Foreign Application Priority Data
Dec. 18, 2019 (JP) 2019-228539

(51) Int. Cl. G02B 6/38; G02B 6/44

(52) U.S. Cl. CPC G02B 6/3825; G02B 6/443; G02B 6/3857; G02B 6/3874

(57) ABSTRACT

A fixing member includes: a base portion configured to be fixed to a housing of an optical connector; and a tubular portion that projects from the base portion in a direction away from the housing in a state where the base portion is fixed to the housing. The tubular portion is configured to cause an optical fiber to be inserted therethrough. The tubular portion includes a protrusion on an outer peripheral surface. The protrusion is configured to be inserted into a mesh hole of a mesh-like protective tube that protects the optical fiber.

### TECHNICAL FIELD

The present disclosure relates to a fixing member, an optical connector, an optical cable with pulling end, and an optical cable laying method.

### BACKGROUND

Patent Document 1 describes a so-called MPO optical connector. In this type of optical connector, a ferrule is retractably housed in a housing. A spring that presses the ferrule and a spring push are housed in the housing.

Patent Document 1 also describes that a caulking ring or a boot is arranged on the rear end side of the spring push. An optical fiber cord is fastened to the housing due to tensile strength fibers or an outer cover of the optical fiber cord being sandwiched between the outer peripheral surface of the cylindrical portion of the spring push on the rear end side and the inner peripheral surface of the caulking ring.

### Patent Literature

[Patent Document 1] JP 2019-184942A

When the caulking ring is crimped, the cylindrical portion arranged inward of the caulking ring may become compressed and damaged.

One or more embodiments of the present invention provide a novel structure for fastening a protective member of an optical fiber to a housing without performing crimping.

### SUMMARY

A fixing member according to one or more embodiments includes: a base portion configured to be fixed to a housing of an optical connector; and a tubular portion that projects from the base portion in a direction away from the housing in a state where the base portion is fixed to the housing, the tubular portion being configured to enable an optical fiber to be inserted therethrough, wherein the tubular portion includes a protrusion on an outer peripheral surface, the protrusion being configured to be inserted into a mesh hole of a mesh-like protective tube that protects the optical fiber.

An optical connector according to one or more embodiments includes: a ferrule; a housing configured to house the ferrule; and a fixing member configured to be fixed to the housing, wherein the fixing member includes a base portion, and a tubular portion that projects from the base portion in a direction away from the housing in a state where the base portion is fixed to the housing, the tubular portion being configured to enable an optical fiber to be inserted therethrough, and the tubular portion includes a protrusion on an outer peripheral surface, the protrusion being configured to be inserted into a mesh hole of a mesh-like protective tube that protects the optical fiber.

An optical cable with pulling end according to one or more embodiments includes: an optical cable; and a terminal structure that includes a pulling end, wherein the terminal structure includes a leading end portion that includes the pulling end, a cable fixing portion configured to be fixed to an outer cover of the optical cable, and a housing portion arranged between the leading end portion and the cable fixing portion, the housing portion houses inside an optical fiber led out from the optical cable, an optical connector attached to an end portion of the optical fiber, and a mesh-like protective tube through which the optical fiber is inserted, the optical connector includes a ferrule, a housing configured to house the ferrule, and a fixing member configured to be fixed to the housing, the fixing member includes a base portion, and a tubular portion that projects from the base portion in a direction away from the housing in a state where the base portion is fixed to the housing, the tubular portion being configured to enable an optical fiber to be inserted therethrough, and the tubular portion includes a protrusion on an outer peripheral surface, the protrusion being configured to be inserted into a mesh hole of the mesh-like protective tube that protects the optical fiber.

Other features of the present invention will become apparent from the following description of the specification and the drawings.

According to the present invention, a protective tube that protects an optical fiber can be fastened to a housing without crimping operation.

### BRIEF DESCRIPTION OF THE DRAWINGS

FIG. 1A is an illustrative diagram of an optical cable with pulling end 100 according to one or more embodiments. FIG. 1B is an illustrative diagram of a method of laying an optical cable 1 using the optical cable with pulling end 100 according to one or more embodiments.

FIG. 2A is an illustrative diagram of an optical connector 10 according to one or more embodiments. FIG. 2B is an illustrative diagram of a state in which a tubular member 30 shown in FIG. 2A has been removed. FIG. 2C is an illustrative diagram of a state in which the tubular member 30 and a protective tube 40 shown in FIG. 2A have been removed.

FIG. 3 is an exploded diagram of the optical connector 10 according to one or more embodiments.

FIGS. 4A and 4B are perspective diagrams of a fixing member 20.

FIG. 5 is an illustrative diagram of the fixing member 20.

FIGS. 6A and 6B are illustrative diagrams of a braided tube.

FIG. 7A is an illustrative diagram of various dimensions of a tubular portion 22 and protrusions 23. FIG. 7B is an illustrative diagram of dimensions of the tubular member 30.

FIG. 8A is an illustrative diagram of a protrusion 23 according to a first variation.

FIG. 8B is an illustrative diagram of protrusions 23 according to a second variation. FIG. 8C is an illustrative diagram of protrusions 23 according to a third variation. FIG. 8D is an illustrative diagram of protrusions 23 according to a fourth variation.

FIG. 9 is an illustrative diagram of the fixing member 20 according to one or more embodiments.

### DETAILED DESCRIPTION

At least the following matter will become apparent from the following description of the specification and the drawings.

A fixing member will become clear, comprising: abase portion configured to be fixed to a housing of an optical connector; and a tubular portion that projects from the base portion in a direction away from the housing in a state where the base portion is fixed to the housing, the tubular portion being configured to enable an optical fiber to be inserted therethrough, wherein the tubular portion includes a protrusion on an outer peripheral surface, the protrusion being configured to be inserted into a mesh hole of a mesh-like protective tube that protects the optical fiber. According to this fixing member, the protective tube that protects the optical fiber can be fastened to the housing without performing crimping.

The tubular portion may include a plurality of the protrusions that are arranged along a lengthwise direction of the tubular portion. According to this configuration, the protective tube is not likely to detach from the tubular portion even if the protective tube is subjected to pulling force.

The tubular portion may include a plurality of the protrusions that protrude in two or more directions from the outer peripheral surface. According to this configuration, the plurality of protrusions are not likely to come out of the mesh holes at the same time, and thus the protective tube is not likely to detach from the tubular portion.

The tubular portion may include a plurality of the protrusions that are respectively arranged on opposite sides of the tubular portion. According to this configuration, even if the protrusions on one side attempt to come out of a mesh hole of the protective tube, the protrusions on the opposite side are not likely to come out of a mesh hole of the protective tube, and thus the plurality of protrusions are not likely to come out of the mesh holes at the same time.

The height of the protrusion may be greater than the diameter of a constituent fiber of the protective tube. According to this configuration, the protrusions can be inserted into mesh holes of the protective tube such that the protrusions pass through the protective tube, and thus the protective tube is not likely to detach from the tubular portion.

One or more embodiments may further comprise: a tubular member configured to sandwich the protective tube together with the outer peripheral surface of the tubular portion. According to this configuration, it is possible to suppress the case where the protective tube detaches from the tubular portion.

A gap between a tip portion of the protrusion and an inner peripheral surface of the tubular member may be smaller than the diameter of a constituent fiber of the protective tube. According to this configuration, the protective tube, which is sandwiched between the outer peripheral surface of the tubular portion and the inner peripheral surface of the tubular member, can be prevented from detaching from the tubular portion.

An optical connector will become clear, comprising: a ferrule; a housing configured to house the ferrule; and a fixing member configured to be fixed to the housing, wherein the fixing member includes a base portion, and a tubular portion that projects from the base portion in a direction away from the housing in a state where the base portion is fixed to the housing, the tubular portion being configured to enable an optical fiber to be inserted therethrough, and the tubular portion includes a protrusion on an outer peripheral surface, the protrusion being configured to be inserted into a mesh hole of a mesh-like protective tube that protects the optical fiber. According to this optical connector, the protective tube that protects the optical fiber can be fastened to the housing without performing crimping.

An optical cable with pulling end will become clear, comprising: an optical cable; and a terminal structure that includes a pulling end, wherein the terminal structure includes a leading end portion that includes the pulling end, a cable fixing portion configured to be fixed to an outer cover of the optical cable, and a housing portion arranged between the leading end portion and the cable fixing portion, the housing portion houses inside an optical fiber led out from the optical cable, an optical connector attached to an end portion of the optical fiber, and a mesh-like protective tube through which the optical fiber is inserted, the optical connector includes a ferrule, a housing configured to house the ferrule, and a fixing member configured to be fixed to the housing, the fixing member includes a base portion, and a tubular portion that projects from the base portion in a direction away from the housing in a state where the base portion is fixed to the housing, the tubular portion being configured to enable an optical fiber to be inserted therethrough, and the tubular portion includes a protrusion on an outer peripheral surface, the protrusion being configured to be inserted into a mesh hole of the mesh-like protective tube that protects the optical fiber. According to this optical cable with pulling end, the protective tube that protects the optical fiber can be fastened to the housing without performing crimping.

An optical cable laying method will become clear, comprising: pulling the pulling end of the optical cable with pulling end according to claim 9; and connecting the optical connector taken out of the housing portion after the pulling. According to this optical cable laying method, the optical fiber is protected by the protective tube that has been fastened to the housing without performing crimping, thus making it possible to suppress the case where the optical fiber becomes damaged during optical cable laying work.

Optical Cable with Pulling End 100

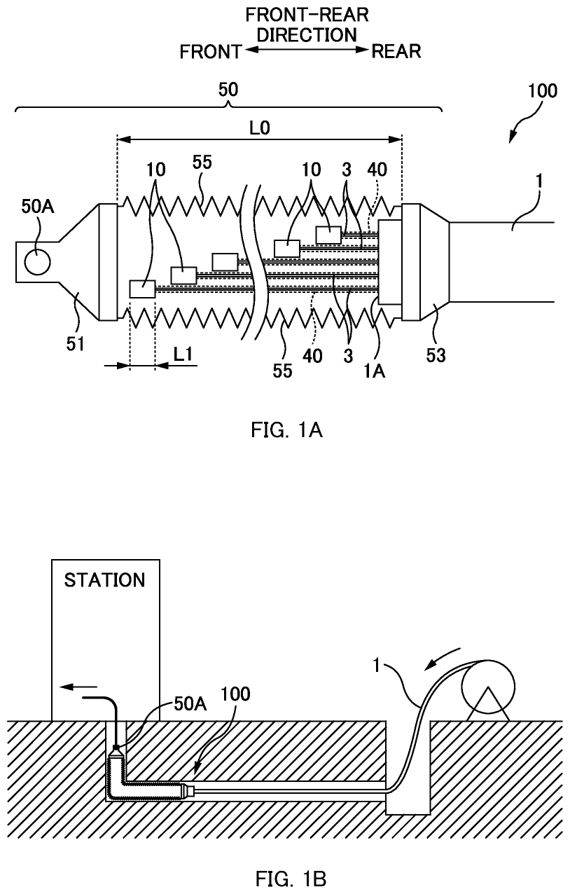

FIG. 1A is an illustrative diagram of an optical cable with pulling end 100 according to one or more embodiments. FIG. 1B is an illustrative diagram of a method of laying an optical cable 1 using the optical cable with pulling end 100 according to one or more embodiments.

In the following description of the optical cable with pulling end 100, as shown in FIG. 1A, the lengthwise direction of the optical cable 1 is defined as the “front-rear direction”. Also, in a view from the optical cable 1, the side corresponding to a lead-out portion 1A (end portion) is defined as the “front” side, and the opposite side to the front side is defined as the “rear” side.

The optical cable with pulling end 100 is an optical cable that is provided with a pulling portion 50A at the end portion. As shown in FIG. 1B, the optical cable 1 can be laid from the outside of a station building to the inside of the station building by pulling the pulling portion 50A of the optical cable with pulling end 100.

The optical cable with pulling end 100 of one or more embodiments includes the optical cable 1 and a terminal structure 50.

The optical cable 1 is a cable in which a large number of optical fibers 3 are housed inside an outer cover. For example, the optical cable 1 of one or more embodiments includes 288 optical fiber ribbons that are each constituted by 12 optical fibers 3, and thus includes a total of 3456 optical fibers 3. However, the number of optical fiber ribbons and optical fibers 3 is not limited to this. The optical fibers 3 extend forward from a lead-out portion 1A (end portion) of the optical cable 1. In one or more embodiments, an optical connector 10 has been attached to the end portion of each of the optical fibers 3 in advance. For this reason, the pulling portion 50A of the optical cable with pulling end 100 can first be pulled (the optical cable 1 can first be laid from the outside of the station building to the inside of the station building), and then connection can be performed using the optical connectors 10 inside the station building, and thus the laying of the optical cable 1 becomes easier. Also, in one or more embodiments, the optical fibers 3 that have been led out from the optical cable 1 have been inserted into protective tubes 40. The optical connectors 10 and the protective tubes 40 will be described later.

The terminal structure 50 is a structure provided at the terminal of the optical cable 1. The terminal structure 50 includes the pulling portion 50A. The pulling portion 50A is a portion for pulling the optical cable 1. As shown in FIG. 1B, the optical cable 1 is pulled into the station building by pulling the pulling portion 50A from inside the station building. The terminal structure 50 includes a leading end portion 51, a cable fixing portion 53, and a housing portion 55.

The leading end portion 51 is the member that constitutes the front portion of the terminal structure 50, and is the member that includes the pulling portion 50A. In other words, the leading end portion 51 is the member that constitutes the pulling end. The leading end portion 51 is attached to the front side of the housing portion 55.

The cable fixing portion 53 is the member that is fixed to the outer cover of the optical cable 1. The cable fixing portion 53 is arranged in the vicinity of the lead-out portion 1A of the optical cable 1 (rearward of the lead-out portion 1A). The housing portion 55 is attached to the front side of the cable fixing portion 53.

The housing portion 55 is a tubular (tube-shaped) member that houses the optical connectors 10. The leading end portion 51 is attached to the front side of the housing portion 55, and the cable fixing portion 53 is attached to the rear side of the housing portion 55. In other words, the housing portion 55 is the member that is arranged between the leading end portion 51 and the cable fixing portion 53. A housing space for housing the optical connectors 10 is formed inside the housing portion 55. In other words, the space surrounded by the housing portion 55, the leading end portion 51, and the cable fixing portion 53 is the housing space for housing the optical connectors 10. The housing portion 55 is constituted by a tube that has flexibility (flexible tube). For example, the housing portion 55 is constituted by a corrugated hollow tube. Because the housing portion 55 is constituted by a flexible tube, the optical cable 1 can be laid by pulling the optical cable 1 along a bent trunk path as shown in FIG. 1B.

In one or more embodiments, an optical connector 10 is attached to the end portion of each of the 288 optical fiber ribbons, and the 288 optical connectors 10 are housed in the housing space of the housing portion 55. In order to house the 288 optical connectors 10 inside the housing portion 55 that has an inner diameter of about 60 mm, the optical connectors 10 are shifted relative to each other in the front-rear direction. Also, in order for the optical connectors 10 that are arranged at shifted positions in the front-rear direction to be housed in the housing portion 55 that has a length L0, a length L1 of the optical connectors 10 may be short. As will be described below, in one or more embodiments, the length L0 of the optical connectors 10 is shortened by simplifying the structure of the rear portion of the optical connector 10.

When laying the optical cable 1, a worker first pulls the pulling portion 50A of the optical cable with pulling end 100. Accordingly, the optical cable 1 can be laid from the outside of the station building to the inside of the station building, for example. After pulling the optical cable with pulling end 100, the worker takes the optical connectors 10 out of the housing portion 55 and performs a connection task using the optical connectors 10. In one or more embodiments, the connection task can be performed using the optical connectors 10 that have been attached to the end portions of the optical fibers 3 in advance, and thus the optical fibers 3 do not need to be subjected to fusion connection or the like in the station building, and therefore the work of laying the optical cable 1 becomes easier.

Note that when the connection task is performed using the optical connectors 10, if the optical fibers 3 (optical fiber core wires) led out from the optical cable 1 are exposed, the optical fibers 3 may become damaged. For this reason, in one or more embodiments, the optical fibers 3 are inserted into the protective tubes 40. Also, in one or more embodiments, the optical connectors 10 are configured such that the protective tubes 40 are fastened by the optical connectors 10.

### Optical Connector 10

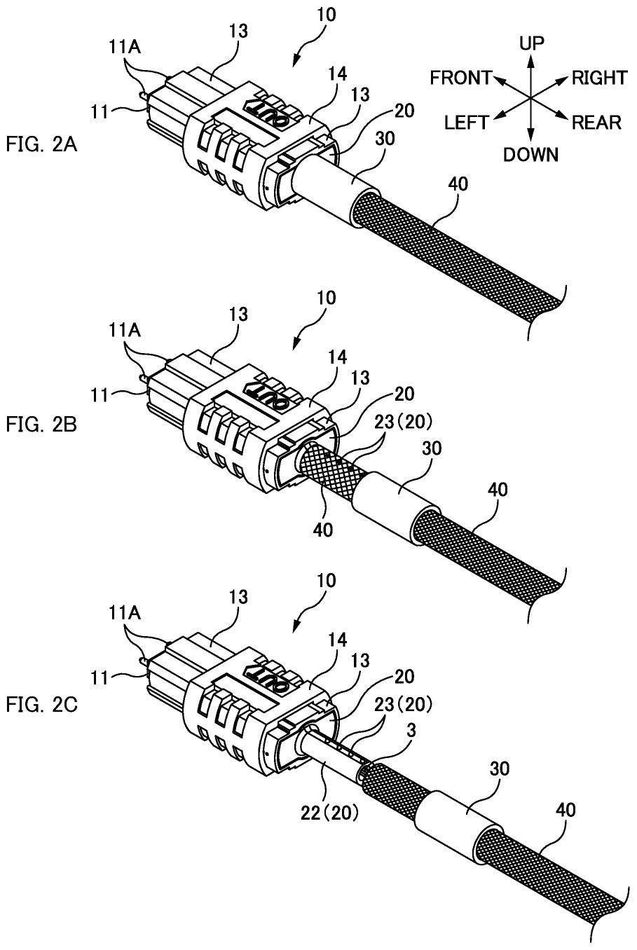

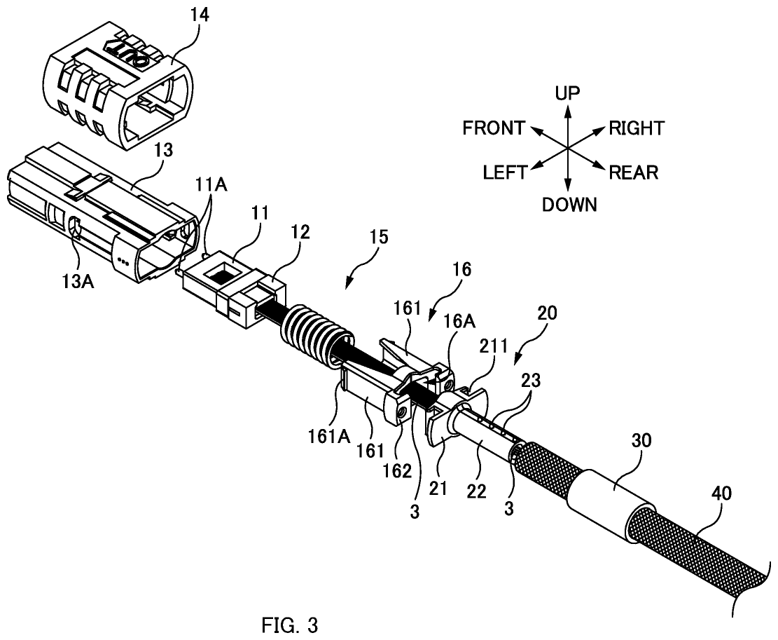

FIG. 2A is an illustrative diagram of the optical connector 10 according to one or more embodiments. FIG. 2B is an illustrative diagram of a state in which the tubular member 30 shown in FIG. 2A has been removed. FIG. 2C is an illustrative diagram of a state in which the tubular member 30 and the protective tube 40 shown in FIG. 2A have been removed. FIG. 3 is an exploded diagram of the optical connector 10 according to one or more embodiments.

In the following description of the optical connector 10, as shown in FIG. 2A, the attachment/detachment direction of the optical connector 10 is defined as the “front-rear direction”. Also, the side corresponding to the partner optical connector (not shown) is defined as the “front” side, and the opposite side to the front side is defined as the “rear” side. Moreover, the width direction of the optical connector 10 (the direction in which a pair of guide pins 11A (or guide holes) of the ferrule 11 are adjacent to each other) is defined as the “left-right direction”, and in a rear-to-front view, the right side is defined as the “right” side, and the opposite side to the right side is defined as the “left” side. Note that the left-right direction will sometimes also be called the “width direction”. Also, the direction perpendicular to the front-rear direction and the left-right direction is defined as the “up-down direction”, the side on which an adhesive filling window (see FIG. 3) of the ferrule 11 is provided is defined as the “up” side, and the opposite side to the up side is defined as the “down” side.

The optical connector 10 of one or more embodiments is a so-called MPO connector (F13 type connector for optical fiber ribbons specified in JIS C 5982). The optical connector 10 of one or more embodiments includes a ferrule 11, a pin clamp 12, a housing 13, a coupling 14, a spring 15, a spring push 16, and a fixing member 20. However, the configuration of the optical connector 10 is not limited to this, and it is sufficient that the ferrule 11, the housing 13, and the fixing member 20 are provided. Note that the optical connector 10 of one or more embodiments is housed in the housing portion 55 of the optical cable with pulling end 100, but it may be an optical connector for another application.

The ferrule 11 is a member that holds the end portions of optical fibers 3. The ferrule 11 of one or more embodiments is a so-called MT ferrule (F12 type connector for optical fiber ribbon specified in JIS C 5981). The ferrule 11 is provided with a plurality of fiber holes, and an optical fiber 3 is inserted into and fixed in each fiber hole. A pin clamp 12 is arranged behind the ferrule 11. The ferrule 11 is pressed forward by the spring 15 via the pin clamp 12. The ferrule 11 includes a flange portion. The flange portion is a portion that protrudes outward from the outer peripheral surface of the ferrule body. The flange portion comes into contact with a projection (not shown) formed on the inner wall surface of the housing 13 to prevent the ferrule 11, which is being pressed forward, from coming out.

The housing 13 is a member that retractably houses the ferrule 11. In addition to the ferrule 11, the housing 13 also houses the pin clamp 12, the spring 15, and the spring push 16. The housing 13 has a tubular shape. The front portion of the ferrule 11 is exposed through an opening on the front side of the housing 13. The fixing member 20 extends through an opening on the rear side of the housing 13. Engagement holes 13A are formed on side surfaces of the housing 13. The engagement holes 13A are holes for engagement with the spring push 16 (specifically, claw portions 161A).

The coupling 14 is a member provided outward of the housing 13, and is a member that can slide in the front-rear direction relative to the housing 13. If the coupling 14 of the optical connector 10 that has been connected to an adapter (not shown) is slid rearward, the optical connector 10 can be removed from the adapter.

The spring 15 is an elastic member that presses the ferrule 11. The spring 15 is arranged between the pin clamp 12 and the spring push 16 in a compressed and deformed state. The front end of the spring 15 is in contact with the pin clamp 12, and the rear end is in contact with the spring push 16. The optical fibers 3 are inserted through the spring 15.

The spring push 16 is a receiving portion (spring receiving member) that fixes the rear end of the spring 15 to the housing 13. The spring push 16 has a pair of arm portions 161, fitting portions 162, and an insertion hole 16A. The arm portions 161 are portions that extend forward from the fitting portions 162, and are portions for engagement with the housing 13. The pair of arm portions 161 are arranged side by side in the left-right direction, and the spring 15 is arranged between the pair of arm portions 161. Claw portions 161A protrude outward from the end portions of the arm portions 161. The spring push 16 is fixed to the housing 13 by engaging the claw portions 161A with the engagement holes 13A of the housing 13. The fitting portions 162 are portions that fix the fixing member 20. The insertion hole 16A is a through hole for insertion of the optical fibers 3.

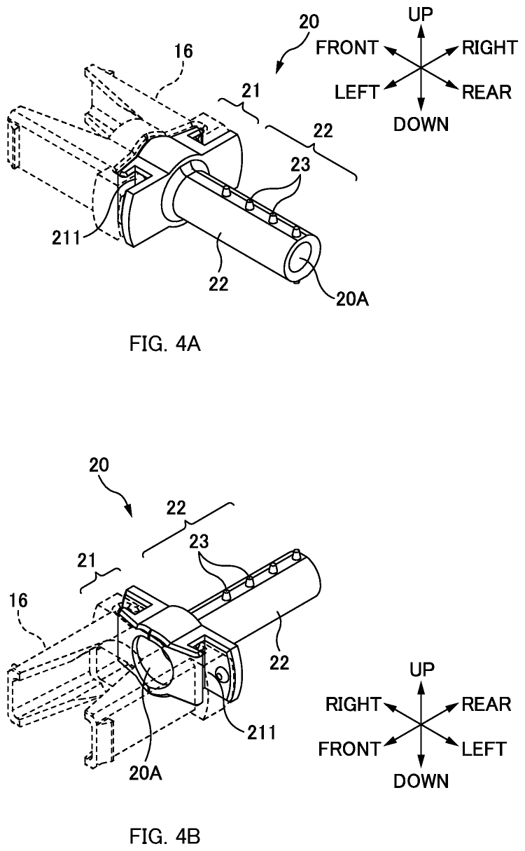

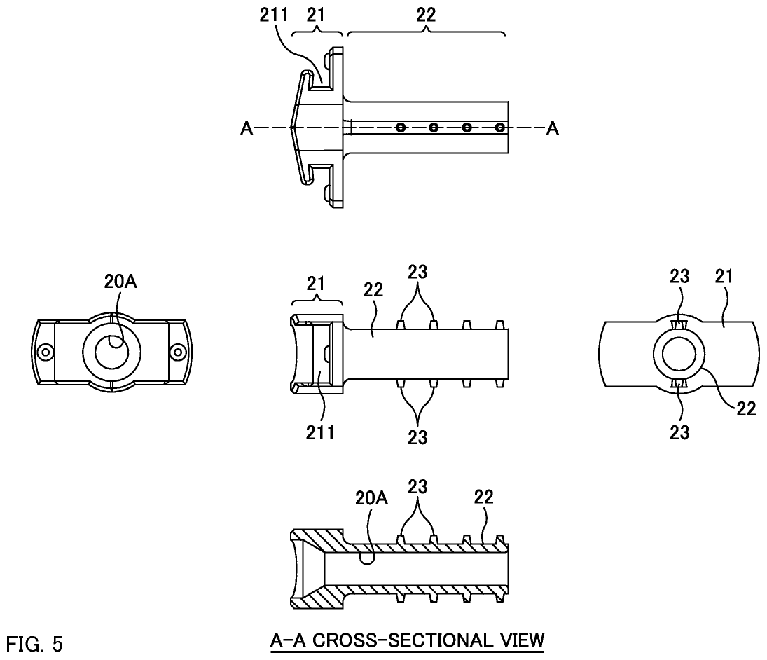

FIGS. 4A and 4B are perspective diagrams of the fixing member 20. FIG. 5 is an illustrative diagram of the fixing member 20.

The fixing member 20 is a member for fixing the end portion of the protective tube 40 to the optical connector 10. The fixing member 20 is a member that is fixed to the housing 13. In one or more embodiments, the fixing member 20 is arranged behind the spring push 16. Also, in one or more embodiments, the fixing member 20 is fixed to the housing 13 via the spring push 16. In other words, in one or more embodiments, the fixing member 20 is indirectly fixed to the housing 13. However, the fixing member 20 may be directly fixed to the housing 13 (e.g., see the embodiments described later). The fixing member 20 includes a base portion 21 and a tubular portion 22.

The base portion 21 is the portion that is fixed to the housing 13. In one or more embodiments, the base portion 21 is the portion that constitutes the front portion of the fixing member 20. In one or more embodiments, the base portion 21 includes fitting portions 211. The fitting portions 211 are portions that are fitted with the fitting portions 162 of the spring push 16. The base portion 21 is fixed to the housing 13 via the spring push 16 by fitting the fitting portions 211 together with the fitting portions 162 of the spring push 16. However, if the fixing member 20 is directly fixed to the housing 13, the base portion 21 does not need to include the fitting portions 211.

The tubular portion 22 is a tubular portion that is located on the rear side of the base portion 21. The tubular portion 22 is a tubular portion that projects from the base portion 21 in a direction away from the housing 13 (here, the rear direction) when the base portion 21 is fixed to the housing 13. In other words, the tubular portion 22 is a tubular portion that protrudes from the rear side of the base portion 21 (the side opposite to the housing 13 in a view from the base portion 21). In one or more embodiments, the tubular portion 22 has a cylindrical shape. However, the tubular portion 22 may have an elliptical shape or may have a square tubular shape. The optical fibers 3 can be inserted through the tubular portion 22. Note that a through hole 20A extends along the front-rear direction through the fixing member 20 so as to be in communication with the internal space of the tubular portion 22, and the optical fibers 3 can be inserted through the fixing member 20 by inserting the optical fibers 3 through the through hole 20A.

In one or more embodiments, the tubular portion 22 includes protrusions 23. Here, the tubular portion 22 includes a plurality of protrusions 23, but the tubular portion 22 may include only one protrusion 23. The protrusions 23 will be described later.

As shown in FIG. 2B, the outer side of the tubular portion 22 is covered by the end portion of the protective tube 40. The protective tube 40 is a tube through which the optical fibers 3 are inserted in order to protect the optical fibers 3. As shown in FIG. 1A, the optical fibers 3 are led out from the optical cable 1 and inserted into the protective tube 40, and thus the optical fibers 3 are protected. Note that the optical fibers 3 (optical fiber core wires) that have been led out from the optical cable 1 are not protected by a member such as the outer cover of an optical fiber cord. For this reason, when the optical cable with pulling end 100 shown in FIG. 1A is manufactured, the optical fibers 3 are led out from the optical cable 1, and then the optical fibers 3 (optical fiber core wires) are inserted into the protective tube 40 in order to protect the optical fibers 3 (also, the ferrule 11 or the like is attached to the end portions of the optical fibers 3 that pass through the protective tube 40, thus forming the optical connector 10). In this way, the protective tube 40 is a member into which the optical fibers 3 are inserted (a member that is retrofitted to the optical fibers 3), and therefore is a member that is different from the outer cover of the optical fiber cord, and is a member that is not included in the optical cable 1.

The protective tube 40 of one or more embodiments is constituted by a mesh-like tube. Specifically, the protective tube 40 is constituted by a braided tube.

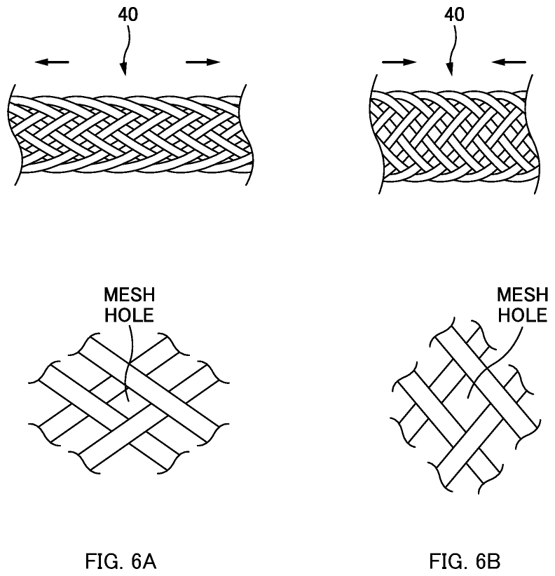

FIGS. 6A and 6B are illustrative diagrams of the braided tube. FIG. 6A is an illustrative diagram of the braided tube stretched in the lengthwise direction. FIG. 6B is an illustrative diagram of the braided tube contracted in the lengthwise direction.

The braided tube is a member constituted by fibers that are woven into a tube shape. Because the braided tube is constructed by weaving fibers, mesh holes are formed at the outer surface. The braided tube can stretch and contract in the lengthwise direction. Because the fibers that constitute the braided tube are simply woven, the intersections of the fibers are not joined together. For this reason, when the braided tube stretches and contracts in the lengthwise direction, the crossing angles between the fibers change, and the diameter of the tube changes. Specifically, when the braided tube stretches in the lengthwise direction, the diameter of the braided tube decreases (see FIG. 6A). Also, when the braided tube contracts in the lengthwise direction, the diameter of the braided tube increases (see FIG. 6B). When the braided tube stretches and contracts in the lengthwise direction, the spacing between the fibers changes, and the size of the mesh holes changes. Specifically, when the braided tube stretches in the lengthwise direction, the fiber spacing decreases and the size of the mesh holes of the braided tube decreases (see FIG. 6A). Also, when the braided tube contracts in the lengthwise direction, the fiber spacing increases and the size of the mesh holes of the braided tube increases (see FIG. 6B).

Note that the protective tube 40 is not limited to being a braided tube, and may be a mesh-like tube (a tube that has mesh holes). For example, the protective tube 40 may be constituted by fibers that are woven into a tube shape, and the intersections of the fibers may be joined. Also, the protective tube 40 need only have mesh holes, and the protective tube 40 does not need to be woven.

As described above, the tubular portion 22 of one or more embodiments has protrusions 23 (see FIGS. 4A, 4B and 5). The protrusions 23 are each a portion (pin-shaped portion) that protrudes outward from the outer peripheral surface of the tubular portion 22. When the mesh-like protective tube 40 (braided tube) is placed around the tubular portion 22, the protrusions 23 can be inserted through mesh holes of the protective tube 40. Accordingly, the protective tube 40 is caught on the tubular portion 22, and thus the protective tube 40 does not easily detach from the tubular portion 22, and the protective tube 40 can be fastened to the optical connector 10. Also, because the protective tube 40 does not easily detach from the tubular portion 22, it is possible to maintain the protection of the optical fibers 3 that extend from the rear side of the optical connector 10. In one or more embodiments, the tubular portion 22 includes the protrusions 23, and thus the protective tube 40 (protective member that protects the optical fibers 3) can be fastened to the housing 13 without crimping a caulking ring. Also, in the one or more embodiments, the protective tube 40 can be fastened to the housing 13 with a simple configuration, and thus the length L0 of the optical connector 10 (see FIG. 1A) can be easily shortened.

In one or more embodiments, the protective tube 40 is constituted by a braided tube, and the diameter of the braided tube changes when the braided tube stretches and contracts in the lengthwise direction (see FIGS. 6A and 6B). For this reason, if the braided tube is compressed in the lengthwise direction such that the diameter of the protective tube 40 (braided tube) increases, the task of covering the tubular portion 22 with the protective tube 40 can be performed easily. Also, after covering the tubular portion 22 with the protective tube 40, if the braided tube is stretched in the lengthwise direction such that the diameter of the protective tube 40 (braided tube) decreases, the task of inserting the protrusions 23 into the mesh holes of the protective tube 40 can be performed easily.

Furthermore, a property of the braided tube is that the mesh holes become smaller as the braided tube stretches in the lengthwise direction (see FIG. 6A). For this reason, when the protective tube 40 is subjected to pulling force while the protrusions 23 protrude through the mesh holes of the protective tube 40 (braided tube), the mesh holes through which the protrusions 23 protrude become tighter (the fibers constituting the mesh tighten around the protrusions 23), and thus the protrusions 23 do not easily come out of the mesh holes. In other words, according to one or more embodiments, the more the protective tube 40 is subjected to pulling force, the more unlikely it is for the protrusions 23 to come out of the mesh holes, and thus the protective tube 40 is not likely to be pulled off the tubular portion 22.

In one or more embodiments, a plurality of protrusions 23 are provided along the front-rear direction (lengthwise direction of the tubular portion 22). Accordingly, when the protective tube 40 is placed around the tubular portion 22, the protrusions 23 can be inserted into mesh holes of the protective tube 40 at a plurality of locations in the front-rear direction. As a result, even if the protective tube 40 is subjected to pulling force at a position rearward of (the direction in which the plurality of protrusions 23 are lined up) the tubular portion 22, the protective tube 40 does not easily detach from the tubular portion 22, and the protective tube 40 can be firmly fastened to optical connector 10. Note that the number of protrusions 23 arranged in the front-rear direction may be one instead of a plurality. However, compared with the case where only one protrusion 23 is provided, a plurality of protrusions 23 may be provided side by side in the front-rear direction (the lengthwise direction of the tubular portion 22) as in the embodiments described here because the protective tube 40 is less likely to detach from the tubular portion 22. Also, instead of arranging a plurality of protrusions 23 side by side in the front-rear direction, a plurality of protrusions 23 may be arranged in a spiral on the cylindrical outer peripheral surface of the tubular portion 22, for example. However, arranging a plurality of protrusions 23 side by side in the front-rear direction as in the embodiments described here makes it possible to simplify the structure of the mold for molding the fixing member 20, and simplifies the manufacturing of the fixing member 20.

Also, in one or more embodiments, when the tubular portion 22 is viewed from the rear side, a plurality of protrusions 23 (here, two protrusions 23) protrude in a plurality of directions (here, two directions) from the outer peripheral surface of the tubular portion 22. In other words, in one or more embodiments, a plurality of protrusions 23 are provided in the circumferential direction of the tubular portion 22. Accordingly, when the protective tube 40 is placed around the tubular portion 22, the plurality of protrusions 23 that protrude in different directions can be inserted through mesh holes of the protective tube 40. Due to the plurality of protrusions 23 that protrude in different directions being inserted into mesh holes of the protective tube 40, the plurality of protrusions 23 are not likely to detach from the mesh at the same time, and thus the protective tube 40 is not likely to detach from the tubular portion 22, and the protective tube 40 can be firmly fastened to the optical connector 10. Note that when the tubular portion 22 is viewed from the rear side, the protrusions 23 may protrude in only one direction. Also, when the tubular portion 22 is viewed from the rear side, a plurality of protrusions 23 may protrude in three or more directions.

In one or more embodiments, when the tubular portion 22 is viewed from the rear side, a plurality of protrusions 23 (here, two protrusions 23) are arranged on opposite sides of the tubular portion 22. Accordingly, even if one of the protrusions 23 attempts to come out of a mesh hole of the protective tube 40, the protrusion 23 on the opposite side is not likely to come out of a mesh hole of the protective tube 40, and thus the plurality of protrusions 23 are not likely to come out of the mesh holes at the same time.

In one or more embodiments, the protective tube 40 is constituted by a braided tube, and a property of the braided tube is that the diameter decreases when subjected to pulling force (see FIG. 6A). For this reason, if the protrusions 23 are arranged on opposite sides of the tubular portion 22 as in the embodiments described here, when the protective tube 40 is subjected to pulling force and the diameter of the protective tube 40 attempts to decrease, the protrusions 23 may come into closer contact with the mesh of the protective tube 40. For this reason, a braided tube may be used as the protective tube 40.

As shown in FIGS. 2A to 2C and FIG. 3, the fixing member 20 of one or more embodiments further includes the tubular member 30.

The tubular member 30 is a cylindrical member that is separate from the main body of the fixing member 20. The tubular member 30 can be fitted around the tubular portion 22. Due to fitting the tubular member 30 around the tubular portion 22, the protective tube 40 can be sandwiched between the outer peripheral surface of the tubular portion 22 and the inner peripheral surface of the tubular member 30. Accordingly, it is possible to suppress the case where the protective tube 40 detaches from the tubular portion 22. Note that the tubular member 30 is simply slid over the tubular portion 22 so as to cover the tubular portion 22, and is not crimped as in the case of a caulking ring. If a caulking ring is crimped, there is a risk of damaging a member inward of the caulking ring, but in one or more embodiments, there is no risk of damaging the tubular portion 22 when the tubular member 30 is attached.

The length of the tubular member 30 in the front-rear direction is substantially the same as the length of the tubular portion 22 in the front-rear direction. Accordingly, the region of the tubular member 30 that covers the tubular portion 22 can sandwich the protective tube 40 together with the tubular portion 22. Note that the length of the tubular member 30 in the front-rear direction may be longer or shorter than the length of the tubular portion 22 in the front-rear direction. The length of the tubular member 30 in the front-rear direction may be set such that the tips of the protrusions 23 of the tubular portion 22 can face the inner peripheral surface of the tubular member 30.

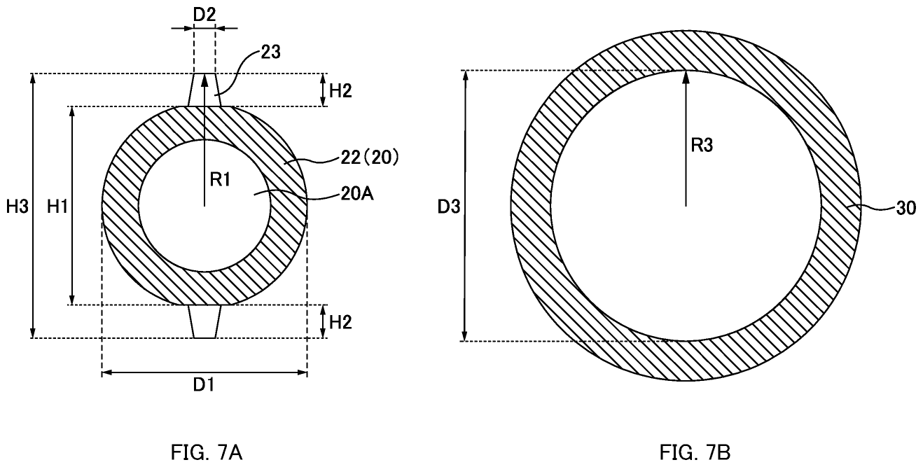

FIG. 7A is an illustrative diagram of various dimensions of the tubular portion 22 and the protrusions 23. FIG. 7B is an illustrative diagram of dimensions of the tubular member 30.

Here, as shown in FIG. 7A, the outer diameter (diameter of the outer peripheral surface) of the tubular portion 22 is defined as D1. Also, the outer dimension of the tubular portion 22 at the portion where the protrusion 23 is formed (here, the dimension of the outer peripheral surface of the tubular portion 22 in the up-down direction) is defined as H1. Note that because the protrusions 23 are formed on flat faces provided on the outer peripheral surface of the cylindrical tubular portion 22, the outer dimension H1 of the tubular portion 22 at the portion where the protrusions 23 are formed is slightly smaller than the outer diameter D1 of the tubular portion 22 (H1<D1). In one or more embodiments, D1 is 3.1 mm and H1 is 3.0 mm. Also, the diameter of the tip portions of the protrusions 23 is defined as D2, and the height of the protrusions 23 is defined as H2. In one or more embodiments, D2 is 0.3 mm and H2 is 0.5 mm. The dimension from the tip portion of one protrusion 23 to the tip portion of the opposite protrusion 23 is defined as H3. In other words, H3 is the maximum outer diameter of the tubular portion 22 including the protrusions 23. H3 is a value obtained by adding the outer dimension H1 of the tubular portion 22 at the portion where the protrusions 23 are formed to twice the height H2 of the protrusions 23 (H3=H2×2+H1). In one or more embodiments, H3 is 4.0 mm. Also, the dimension from the center of the tubular portion 22 to the tip portion of one protrusion 23 is defined as R1. In other words, R1 is the maximum radius of the tubular portion 22 including one protrusion 23. For this reason, the dimension R1 from the center of the tubular portion 22 to the tip portion of one protrusion 23 is half of H3 (R1=H3×0.5). In one or more embodiments, R1 is 2.0 mm.

Also, here, as shown in FIG. 7B, the inner diameter (diameter of the inner peripheral surface) of the tubular member 30 is defined as D3. Also, the radius of the inner peripheral surface of the tubular member 30 is defined as R3.

In one or more embodiments, the height H2 of the protrusions 23 is larger than the diameter of the fibers that constitute the protective tube 40 (braided tube). In other words, the height H2 of the protrusion 23 is larger than the thickness of the protective tube 40 (braided tube). Accordingly, the protrusions 23 can be inserted in the mesh holes of the protective tube 40 such that the protrusions 23 pass through the protective tube 40, and thus the protective tube 40 is not likely to detach from the tubular portion 22. In one or more embodiments, the diameter of the fibers that constitute the braided tube is 0.3 mm, and the height of the protrusions 23 is set to 0.5 mm. However, the diameter of the fibers and the height of the protrusions 23 are not limited to this. As long as the protrusions 23 are inserted into the mesh holes of the protective tube 40, the protective tube 40 is less likely to detach from the tubular portion 22 than in the case where the protrusions 23 are not provided, and thus the height H2 of the protrusions 23 is permitted to be smaller than the diameter of the fibers that make up the protective tube 40 (braided tube).

Also, in one or more embodiments, H3, which is the maximum outer diameter of the tubular portion 22 including the protrusions 23, is smaller than the inner diameter D3 of the tubular member 30. For this reason, when the tubular member 30 is fitted around the tubular portion 22, a gap is formed between the inner peripheral surface of the tubular member 30 and the tip portions of the protrusions 23. The gap between the inner peripheral surface of the tubular member 30 and the tip portions of the protrusions 23 may be smaller than the diameter of the fibers that constitute the protective tube 40 (braided tube). Accordingly, the protective tube 40, which is sandwiched between the outer peripheral surface of the tubular portion 22 and the inner peripheral surface of the tubular member 30, can be prevented from detaching from the tubular portion 22.

The gap between the tip portion of the protrusion 23 and the inner peripheral surface of the tubular member 30 is, at the widest, a value obtained by subtracting the maximum outer diameter H3 of the tubular portion 22 including the protrusions 23 from the inner diameter D3 of the tubular member 30 (=D3−H3). For this reason, the value obtained by subtracting the maximum outer diameter H3 of the tubular portion 22 including the protrusions 23 from the inner diameter D3 of the tubular member 30 (=D3−H3) may be smaller than the diameter of the fibers that constitute the protective tube 40 (braided tube). In one or more embodiments, H3, which is the maximum outer diameter of the tubular portion 22 including the protrusions 23, is 4.0 mm, and the inner diameter D3 of the tubular member 30 is 4.1 mm. For this reason, the maximum size of the gap between the inner peripheral surface of the tubular member 30 and the tip portions of the protrusions 23 is 0.1 mm (=4.1 mm−4.0 mm), which is smaller than the diameter 0.3 mm of the fibers that constitute the braided tube.

If the center of the tubular member 30 matches the center of the tubular portion 22, the gap between the inner peripheral surface of the tubular member 30 and the tip portions of the protrusions 23 is a value obtained by subtracting the radius R3 of the inner peripheral surface of the tubular member 30 from the dimension R1, which is the dimension from the center of the tubular portion 22 to the tip portion of one protrusion 23 (=R1−R3). For this reason, the value obtained by subtracting the radius R3 of the inner peripheral surface of the tubular member 30 from the dimension R1, which is the dimension from the center of the tubular portion 22 to the tip portion of one protrusion 23 (=R1−R3), may be smaller than the diameter of the fibers that constitute the protective tube 40 (braided tube). Even in this case, the protective tube 40, which is sandwiched between the outer peripheral surface of the tubular portion 22 and the inner peripheral surface of the tubular member 30, is not likely to detach from the tubular portion 22. Note that if the protective tube 40 is sandwiched between the outer peripheral surface of the tubular portion 22 and the inner peripheral surface of the tubular member 30, the protective tube 40 is not likely to detach from the tubular portion 22, and therefore the gap between the inner peripheral surface of the tubular member 30 and the tip portions of the protrusions 23 is permitted to be larger than the diameter of the fibers that constitute the protective tube 40 (braided tube).

In one or more embodiments, the protective tube 40 is constituted by a braided tube, and the diameter of the braided tube changes when the braided tube stretches and contracts in the lengthwise direction (see FIGS. 6A and 6B). The braided tube of one or more embodiments can increase in size such that the diameter thereof (specifically, the inner diameter of the protective tube 40) is larger than the maximum outer diameter H3 of the tubular portion 22 including the protrusions 23. Also, the braided tube of one or more embodiments can decrease in size such that the diameter thereof (specifically, the inner diameter of the protective tube 40) is smaller than the outer diameter D1 of the tubular portion 22. This facilitates the task of inserting the protrusions 23 into mesh holes of the protective tube 40.

Variations

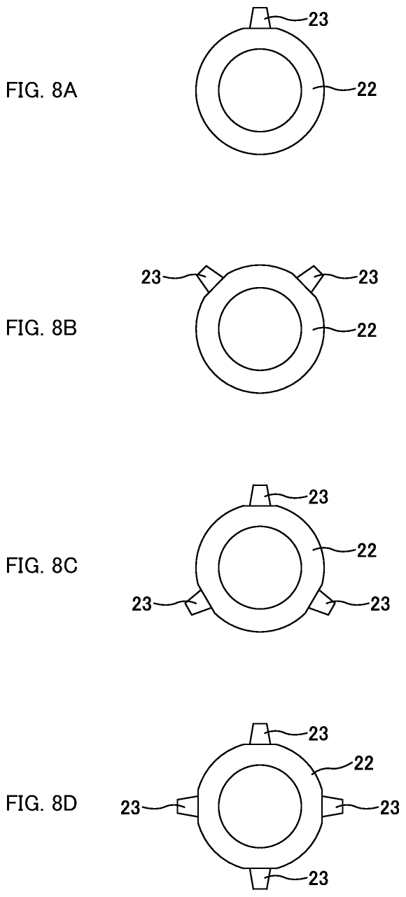

FIG. 8A is an illustrative diagram of a protrusion 23 according to a first variation. In the first variation, when the tubular portion 22 is viewed from the rear side, one protrusion 23 protrudes from the outer peripheral surface of the tubular portion 22. In other words, in the first variation, a protrusion 23 protrudes in only one direction. In the first variation, the protective tube 40 can more easily detach from the tubular portion 22 than in the case where a plurality of protrusions 23 protrude from the outer peripheral surface of the tubular portion 22 in a plurality of directions as in the above-described embodiments. However, unlike the case where no protrusions 23 are provided, the protrusion 23 can be inserted into a mesh hole of the protective tube 40 in the first variation as well, and thus the protective tube 40 is less likely to detach from the tubular portion 22.

FIG. 8B is an illustrative diagram of protrusions 23 according to a second variation. In the second variation, two protrusions 23 respectively protrude in two directions from the outer peripheral surface of the tubular portion 22, but the two protrusions 23 are not arranged on opposite sides of the tubular portion 22. In the second variation, the protective tube 40 can more easily detach from the tubular portion 22 than in the case where two protrusions 23 are arranged on opposite sides of the tubular portion 22 as in the above-described embodiments. However, in the embodiments described later as well, when the protective tube 40 is placed around the tubular portion 22, the plurality of protrusions 23 that protrude in different directions can be inserted through mesh holes of the protective tube 40, and thus the protective tube 40 is not likely to detach from the tubular portion 22.

FIG. 8C is an illustrative diagram of protrusions 23 according to a third variation. FIG. 8D is an illustrative diagram of protrusions 23 according to a fourth variation. In the third variation and the fourth variation, a plurality of protrusions 23 (here, three or four protrusions 23) protrude in a plurality of directions (here, three or four directions) from the outer peripheral surface of the tubular portion 22. In other words, in the third variation and the fourth variation, a plurality of protrusions 23 are provided in the circumferential direction of the tubular portion 22. Accordingly, when the protective tube 40 is placed around the tubular portion 22, the plurality of protrusions 23 that protrude in different directions can be inserted through mesh holes of the protective tube 40.

Note that in the case where a plurality of protrusions 23 are provided in the circumferential direction of the tubular portion 22, the protrusions 23 may be arranged with equal intervals therebetween in the circumferential direction as shown in the above-described embodiments, the third variation, and the fourth variation. Accordingly, even if one of the protrusions 23 attempts to come out of a mesh hole of the protective tube 40, another protrusion 23 is unlikely to come out of a mesh hole of the protective tube 40, and thus the plurality of protrusions 23 are not likely to come out of the mesh holes at the same time.

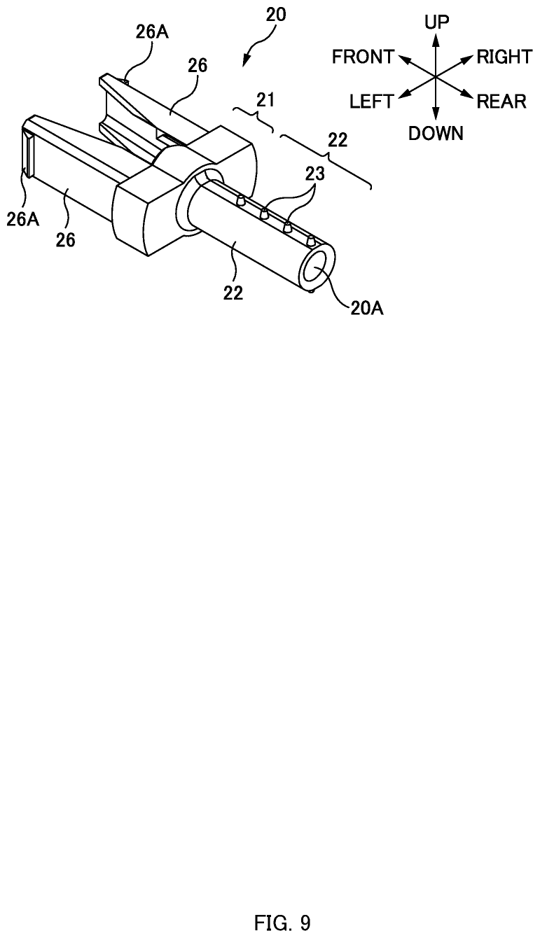

FIG. 9 is an illustrative diagram of the fixing member 20 according to one or more embodiments.

The fixing member 20 of one or more embodiments is a member for fixing the end portion of the protective tube 40 to the optical connector 10, and also has the functionality of the spring push 16 described above. The fixing member 20 of one or more embodiments includes a base portion 21 and a tubular portion 22 similarly to the above-described embodiments, and also includes a pair of arm portions 26. The arm portions 26 are portions that extend forward from the base portion 21, and are portions that engage with the housing 13. The pair of arm portions 26 are arranged side by side in the left-right direction, and the spring 15 is arranged between the pair of arm portions 26. The fixing member 20 is fixed to the housing 13 due to claw portions 26A at end portions of the arm portions 26 engaging with the engagement holes 13A of the housing 13. In other words, in one or more embodiments, the fixing member 20 is directly fixed to the housing 13.

In one or more embodiments described here as well, the fixing member 20 includes the base portion 21 and the tubular portion 22, and protrusions 23 are provided on the outer peripheral surface of the tubular portion 22. In one or more embodiments described here as well, when the mesh-like protective tube 40 (braided tube) is placed around the tubular portion 22, the protrusions 23 can be inserted into mesh holes of the protective tube 40. Accordingly, the protective tube 40 is caught on the tubular portion 22, and thus the protective tube 40 does not easily detach from the tubular portion 22, and the protective tube 40 can be fastened to the optical connector 10. Also, because the protective tube 40 does not easily detach from the tubular portion 22, it is possible to maintain the protection of the optical fibers 3 that extend from the rear side of the optical connector 10.

Note that the fixing member 20 is not limited to the modes shown in the above-described embodiments. As long as the fixing member 20 includes the base portion 21 and the tubular portion 22, and one or more protrusions 23 are provided on the outer peripheral surface of the tubular portion 22, the protrusions 23 can be inserted into mesh holes of the mesh-like protective tube 40 when the protective tube 40 is placed around the tubular portion 22.

Other Remarks

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 optical cable, 1A lead-out portion, 3 optical fiber,
10 optical connector, 11 ferrule, 11A guide pin,
12 pin clamp, 13 housing, 13A engagement hole,
14 coupling, 15 spring,
16 spring push, 16A insertion hole,
161 arm portion, 161A claw portion, 162 fitting portion,
20 fixing member, 20A through hole,
21 base portion, 211 fitting portion,
22 tubular portion, 23 protrusion,
26 arm portion, 26A claw portion,
30 tubular member, 40 protective tube,
50 terminal structure, 50A pulling portion,
51 leading end portion, 53 cable fixing portion, 55 housing portion,
100 optical cable with pulling end

1. A fixing member comprising:
a base portion configured to be fixed to a housing of an optical connector; and
a tubular portion that projects from the base portion in a direction away from the housing in a state where the base portion is fixed to the housing, wherein
the tubular portion is configured to cause an optical fiber to be inserted therethrough,
the tubular portion comprises a protrusion on an outer peripheral surface, and
the protrusion is configured to be inserted into a mesh hole of a mesh-like protective tube that protects the optical fiber.

2. The fixing member according to claim 1, wherein
the tubular portion further comprises one or more other protrusions on the outer peripheral surface that are configured to be inserted into mesh holes, and
the protrusions are arranged along a lengthwise direction of the tubular portion.

3. The fixing member according to claim 1, wherein
the tubular portion further comprises one or more other protrusions on the outer peripheral surface that are configured to be inserted into mesh holes, and
the protrusions protrude in two or more directions from the outer peripheral surface.

4. The fixing member according to claim 1, wherein
the tubular portion further comprises one or more other protrusions on the outer peripheral surface that are configured to be inserted into mesh holes, and
the protrusions are respectively arranged on opposite sides of the tubular portion.

5. The fixing member according to claim 1, wherein a height of the protrusion is greater than a diameter of a constituent fiber of the protective tube.

6. The fixing member according to claim 1, further comprising:
a tubular member, wherein
the tubular member and the outer peripheral surface of the tubular portion are configured to sandwich the protective tube.

7. The fixing member according to claim 6, wherein a gap between a tip portion of the protrusion and an inner peripheral surface of the tubular member is smaller than a diameter of a constituent fiber of the protective tube.

8. An optical connector comprising:
a ferrule;
a housing that houses the ferrule; and
a fixing member fixed to the housing, wherein
the fixing member comprises:
a base portion, and
a tubular portion that projects from the base portion in a direction away from the housing in a state where the base portion is fixed to the housing,
the tubular portion is configured to cause an optical fiber to be inserted therethrough,
the tubular portion comprises a protrusion on an outer peripheral surface, and
the protrusion is configured to be inserted into a mesh hole of a mesh-like protective tube that protects the optical fiber.

9. An optical cable, comprising:
an optical cable; and
a terminal structure, wherein
the terminal structure comprises:
a leading end portion that comprises a pulling end,
a cable fixing portion fixed to an outer cover of the optical cable, and
a housing portion disposed between the leading end portion and the cable fixing portion,
the housing portion houses inside:
an optical fiber led out from the optical cable,
an optical connector attached to an end portion of the optical fiber; and
a mesh-like protective tube through which the optical fiber is inserted,
the optical connector comprises:
a ferrule,
a housing that houses the ferrule, and
a fixing member fixed to the housing,
the fixing member comprises:
a base portion; and
a tubular portion that projects from the base portion in a direction away from the housing in a state where the base portion is fixed to the housing,
the tubular portion is configured to cause an optical fiber to be inserted therethrough,
the tubular portion comprises a protrusion on an outer peripheral surface, and
the protrusion is configured to be inserted into a mesh hole of the mesh-like protective tube that protects the optical fiber.

10. An optical cable laying method comprising:
pulling a pulling end of the optical cable according to claim 9; and
connecting the optical connector taken out of the housing portion after the pulling.
